(19) United States
(12) Patent Application Publication
(10) Pub. No.: US 2025/0135476 A1
(43) Pub. Date: May 1, 2025

(54) MISTING FAN

(71) Applicant: Nanjing Chervon Industry Co., Ltd., Nanjing (CN)

(72) Inventors: Zhijun Chen, Nanjing (CN); Mingshun E, Nanjing (CN); Bo Yang, Nanjing (CN); Aowen Xu, Nanjing (CN)

(21) Appl. No.: 18/894,161

(22) Filed: Sep. 24, 2024

(30) Foreign Application Priority Data
Nov. 1, 2023 (CN) 202311446050.8

(51) Int. Cl. B05B 5/04; F21L 4/00; F21V 33/00

(52) U.S. Cl. CPC B05B 5/0411; B05B 5/0415; F21L 4/00; F21V 33/0096

(57) ABSTRACT

A misting fan includes a fan assembly including fan blades and a first electric motor for driving the fan blades to rotate; a body formed with a frame for supporting the fan assembly; and a nozzle disposed on the fan assembly and/or the body. The body is formed with a first accommodation cavity for water storage, and the first accommodation cavity is disposed around the fan assembly. In a circumferential direction, an angle of the first accommodation cavity around the fan assembly is greater than or equal to 180°. The misting fan further includes a pump component for pumping water in the first accommodation cavity to the nozzle.

### RELATED APPLICATION INFORMATION

This application claims the benefit under 35 U.S.C. § 119(a) of Chinese Patent Application No. 202311446050.8, filed on Nov. 1, 2023, which application is incorporated herein by reference in its entirety.

### TECHNICAL FIELD

The present application relates to a fan and, in particular, to a misting fan.

### BACKGROUND

A misting fan lowers the temperature through the absorption of heat by water during evaporation. Meanwhile, the misting fan can increase the relative humidity in the air, reduce dust, and purify the air. The misting fan has a wide range of application scenarios due to multiple functions of the misting fan. In some places with sockets, the misting fan can use external mains electricity as an energy source. In some places far away from mains electricity or lacking in sockets, the misting fan can be connected to a small battery pack for use. Currently, a water tank used by the existing misting fan is separated from the misting fan, and the water tank is independent of the misting fan.

This part provides background information related to the present application, and the background information is not necessarily the existing art.

### SUMMARY

A misting fan includes a fan assembly including fan blades and a first electric motor for driving the fan blades to rotate; a body formed with a frame for supporting the fan assembly; and a nozzle disposed on the fan assembly and/or the body. The body is formed with a first accommodation cavity for water storage, and the first accommodation cavity is disposed around the fan assembly. In a circumferential direction, an angle of the first accommodation cavity around the fan assembly is greater than or equal to 180°. The misting fan further includes a pump component for pumping water in the first accommodation cavity to the nozzle.

In some examples, in the circumferential direction, the angle of the first accommodation cavity around the fan assembly is equal to 360°, and the first accommodation cavity encircles the fan assembly so that the fan assembly is supported by a frame of a housing of the first accommodation cavity.

In some examples, the nozzle is disposed on a housing of the first accommodation cavity.

In some examples, the nozzle is detachable.

In some examples, the housing of the first accommodation cavity further includes a nozzle receiving groove matching the nozzle, and when the nozzle has no need to spray water, the nozzle is received in the nozzle receiving groove and does not protrude from an outer surface of the body.

In some examples, the body is further provided with a water filling port through which water is injected into the first accommodation cavity.

In some examples, the first accommodation cavity is made of a light-transmissive material and the first accommodation cavity is configured to display a water storage capacity of the misting fan.

In some examples, the first accommodation cavity is further configured to scatter a light source to provide regional lighting for a region where the misting fan is located.

In some examples, a light-emitting device is disposed at a connection between a housing of the first accommodation cavity and the fan assembly, and the light-emitting device provides, through the first accommodation cavity, the regional lighting for the region where the misting fan is located.

In some examples, the misting fan further includes an angle adjustment component, where the angle adjustment component is disposed on a housing of the first accommodation cavity and configured to adjust an angle at which the misting fan operates.

In some examples, the angle adjustment component enables the misting fan to operate at an angle greater than or equal to 0° and less than or equal to 90°.

In some examples, the misting fan further includes a battery assembly including a battery pack for powering the first electric motor, where the battery pack is detachably connected to the body.

In some examples, the body is further formed with a second accommodation cavity, and the battery assembly is disposed in the second accommodation cavity.

In some examples, the fan assembly further includes a fan with a diameter greater than or equal to 5 inches and less than or equal to 20 inches.

In some examples, left and right side surfaces of the first accommodation cavity are two planes parallel to each other, and the left and right side surfaces enable the misting fan to be clamped and fixed between a windowsill and a window.

In some examples, a misting fan includes a fan assembly including fan blades and an electric motor for driving the fan blades to rotate; a body formed with a frame for supporting the fan assembly; and a nozzle disposed on the fan assembly and/or the body. The body is formed with a first accommodation cavity for water storage, and the volume of the first accommodation cavity is less than or equal to 20 L. The misting fan further includes a pump component for pumping water in the first accommodation cavity to the nozzle.

In some examples, the length of the first accommodation cavity is less than or equal to 600 mm, the width of the first accommodation cavity is less than or equal to 400 mm, and the thickness of the first accommodation cavity is less than or equal to 200 mm.

In some examples, the first accommodation cavity is made of a light-transmissive material and the first accommodation cavity is configured to display a water storage capacity of the misting fan.

In some examples, the first accommodation cavity is further configured to scatter a light source to provide regional lighting for a region where the misting fan is located.

In some examples, a light-emitting device is disposed at a connection between a housing of the first accommodation cavity and the fan assembly, and the light-emitting device provides, through the first accommodation cavity, the regional lighting for the region where the misting fan is located.

In some examples, the first accommodation cavity is made by a blow molding process.

In some examples, the misting fan further includes a handle component disposed on a housing of the first accommodation cavity.

In some examples, a water filling port includes a filtering assembly configured to filter water injected into the first accommodation cavity.

In some examples, when the first accommodation cavity has a maximum water storage capacity, the misting fan operates for a maximum time greater than or equal to 1 h.

In some examples, the misting fan further includes an angle adjustment component, where the angle adjustment component is disposed on a housing of the first accommodation cavity and configured to adjust an angle at which the misting fan operates.

In some examples, a misting fan includes a fan assembly including fan blades and a first electric motor for driving the fan blades to rotate; a body formed with a frame for supporting the fan assembly; and a nozzle disposed on the fan assembly and/or the body. The body is formed with a first accommodation cavity for water storage and further provided with a water filling port through which water is injected into the first accommodation cavity. The misting fan further includes a pump component for pumping water in the first accommodation cavity to the nozzle.

In some examples, the misting fan further includes a water inlet pipe, where one end of the water inlet pipe is connected to the first accommodation cavity to acquire water from the first accommodation cavity, and the other end of the water inlet pipe is connected to the pump component to receive the water acquired from the first accommodation cavity.

In some examples, the misting fan further includes a water outlet pipe, where one end of the water outlet pipe is connected to the pump component to acquire water from the pump component, and the other end of the water outlet pipe is connected to the nozzle to provide the water for the nozzle.

In some examples, the misting fan further includes a second electric motor for driving the pump component to operate, where the second electric motor is configured to drive the pump component to pump the water in the first accommodation cavity to the nozzle.

In some examples, the misting fan further includes a battery pack for powering the first electric motor and the second electric motor.

In some examples, the body is further formed with a second accommodation cavity, and the pump component is disposed in the second accommodation cavity.

In some examples, the misting fan further includes a water mist adjustment component configured to control an amount of water that the pump component pumps from the first accommodation cavity to the nozzle.

In some examples, the operating power of the pump component is less than or equal to 10 W.

In some examples, the misting fan further includes an angle adjustment component, where the angle adjustment component is disposed on the body and configured to adjust an angle at which the misting fan operates.

In some examples, the body further includes a receiving groove matching the angle adjustment component; and when the angle adjustment component is received in the receiving groove, the angle adjustment component does not protrude from an outer surface of the body.

In some examples, the angle adjustment component enables the misting fan to operate at an angle greater than or equal to 0° and less than or equal to 90°.

In some examples, a misting fan includes a fan assembly including fan blades and a first electric motor for driving the fan blades to rotate; a body formed with a frame for supporting the fan assembly; a nozzle disposed on the fan assembly and/or the body; and a battery assembly including a battery pack for powering the first electric motor. The battery pack is detachably connected to the body. The body is formed with a first accommodation cavity for water storage and further provided with a water filling port through which water is injected into the first accommodation cavity.

In some examples, the battery pack is configured to power another power tool after detached from the misting fan.

In some examples, when the battery pack is mounted in the body, the first accommodation cavity is at least partially located on the upper side of the battery pack in an up and down direction.

In some examples, the body is further formed with a second accommodation cavity, and the battery assembly is disposed in the second accommodation cavity.

In some examples, the battery pack is mounted into the second accommodation cavity along a left and right direction.

In some examples, when the battery pack is mounted in the body, the thickness of the battery pack in a direction of a fan blade shaft of the fan blades is less than or equal to 90 mm.

In some examples, the misting fan further includes a pump component for pumping water in the first accommodation cavity to the nozzle and a second electric motor for driving the pump component to operate; and the battery pack is further configured to power the second electric motor.

In some examples, the nominal voltage of the battery pack is greater than or equal to 6 V and less than or equal to 56V.

In some examples, a working current of the battery pack is greater than or equal to 0.5 A and less than or equal to 5 A.

In some examples, the battery pack supports the misting fan in operating for 1 h or more.

In some examples, a misting fan includes a fan assembly including a fan and an electric motor for driving the fan to rotate; a body formed with a frame for supporting the fan assembly; and a nozzle disposed on the fan assembly and/or the body. The body is formed with a first accommodation cavity for water storage. The diameter of the fan is greater than or equal to 5 inches and less than or equal to 20 inches.

In some examples, the fan assembly further includes a front fan grille and a rear fan grille, and neither the front fan grille nor the rear fan grille protrudes from an outer surface of the body.

In some examples, the operating power of the fan assembly is greater than or equal to 3 W and less than or equal to 15 W.

In some examples, the fan assembly operates at a wind speed greater than or equal to 2.5 m/s.

In some examples, the nozzle is disposed on the front fan grille.

In some examples, the nozzle is detachable.

In some examples, the front fan grille further includes a nozzle receiving groove matching the nozzle, and when the nozzle has no need to spray water, the nozzle is received in the nozzle receiving groove and does not protrude from the outer surface of the body.

In some examples, the number of nozzles disposed on the front fan grille is greater than or equal to 1.

In some examples, the nozzle sprays water intermittently.

In some examples, the misting fan further includes a wind speed adjustment component configured to adjust a wind speed of the fan assembly.

In some examples, a misting fan includes a fan assembly including fan blades and an electric motor for driving the fan blades to rotate; a body formed with a frame for supporting the fan assembly; and a nozzle disposed on the fan assembly and/or the body. The body is formed with a first accommodation cavity for water storage, left and right side surfaces of the first accommodation cavity are two planes parallel to each other, and the left and right side surfaces enable the misting fan to be clamped and fixed between a windowsill and a window.

In some examples, the length of the body is less than or equal to 600 mm and the width of the body is less than or equal to 400 mm.

In some examples, the length of the body is less than or equal to 600 mm and the thickness of the body is less than or equal to 200 mm.

In some examples, the misting fan further includes a battery pack for powering the misting fan.

In some examples, the misting fan further includes a plug component for mating with a socket to power the misting fan.

The present application has the following benefits: the body is used as the frame for supporting the fan assembly and a water storage device so that the misting fan is an integral misting fan where a water tank is integrated with the body. Since the body of the misting fan is integrated with the water tank, the misting fan is convenient for a user to use and store.

### BRIEF DESCRIPTION OF THE DRAWINGS

FIG. 1 is a front view of a misting fan according to an example.

FIG. 2 is a side view of the misting fan of FIG. 1.

FIG. 3 is a front view of a fan assembly of the misting fan of FIG. 1.

FIG. 4 is a front view of a pump component and related structures of the misting fan of FIG. 1.

FIG. 5 is a front view of a battery assembly of the misting fan of FIG. 1.

FIG. 6 is a side view of a battery assembly of the misting fan of FIG. 1.

FIG. 7 is a front view of a water mist adjustment component and a wind speed adjustment component of the misting fan of FIG. 1.

FIG. 8 is a side perspective view of an angle adjustment component of the misting fan of FIG. 1.

FIG. 9 is a front view of a light-emitting device of a misting fan according to an example.

FIG. 10 is a top view of a handle component and a water filling port of the misting fan of FIG. 1.

FIG. 11 is a front view of an angle of a first accommodation cavity of a misting fan according to an example.

FIG. 12 is a front view of an angle of a first accommodation cavity of the misting fan of FIG. 1.

FIG. 13 is a front view of a nozzle of a misting fan according to an example.

FIG. 14 is a rear view of a misting fan according to an example.

FIG. 15 is a front view of a misting fan according to an example.

FIG. 16 is a front view of a misting fan used as a window fan according to an example.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

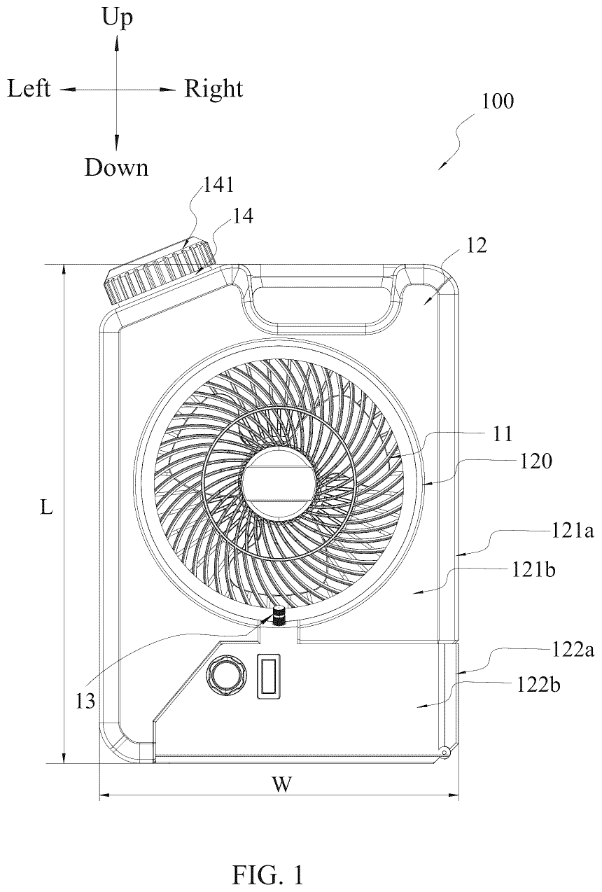

FIG. 1 shows a misting fan 100 that implements blowing and spraying functions to blow out a wind with water mist and can cool and humidify a preset field. The misting fan 100 is applicable to outdoor places such as basketball courts, parks, and playgrounds. The misting fan 100 is also applicable to indoor places such as shopping malls, factories, and warehouses.

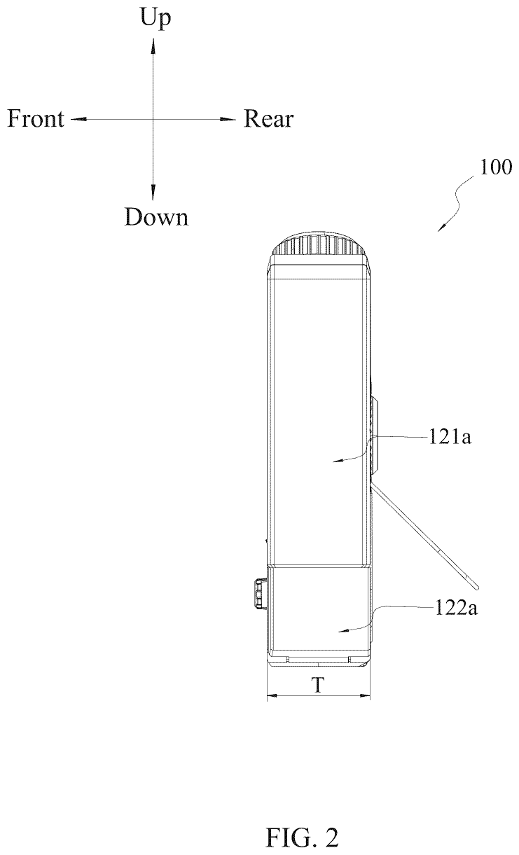

As shown in FIGS. 1 and 2, the misting fan 100 includes a fan assembly 11, a body 12, a nozzle 13, and a water filling port 14. The body 12 is formed with a frame 120 for supporting the fan assembly 11. The body 12 includes a first housing 121a and a second housing 122a. The first housing 121a is formed with a first accommodation cavity 121b for accommodating water. The second housing 122a is formed with a second accommodation cavity 122b. The water filling port 14 is used for water injection into the first accommodation cavity 121b. The water filling port 14 is provided with a sealing component 141 matching the water filling port 14 so that when water injection is completed through the water filling port 14, the water filling port 14 is closed by the sealing component 141.

To illustrate the technical solutions of the present application, a front side, a rear side, a left side, a right side, an upper side, and a lower side shown in FIGS. 1 and 2 are defined. As shown in FIGS. 1 and 2, the body 12 is a cubic structure. In some examples, the length L of the body 12 in an up and down direction is less than or equal to 600 mm; the width W of the body 12 in a left and right direction is less than or equal to 400 mm; and the thickness T of the body 12 in a front and rear direction is less than or equal to 200 mm. The body 12 is configured to have a structure in a regular shape so that the misting fan 100 is easier to store.

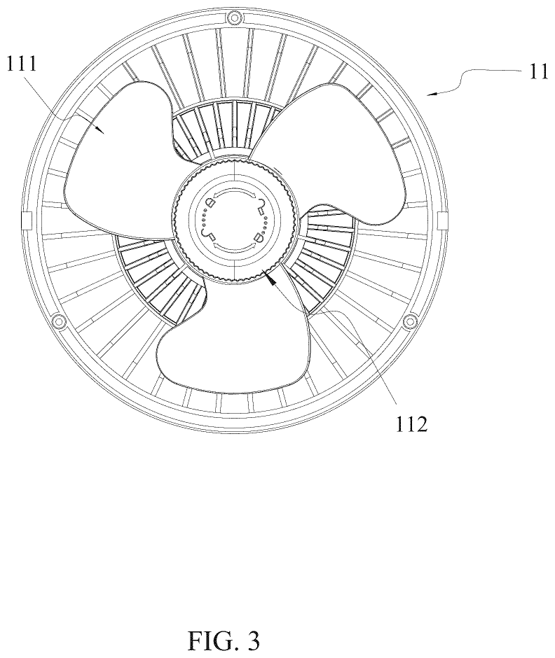

As shown in FIG. 3, the fan assembly 11 includes fan blades 111 and a first electric motor 112 for driving the fan blades 111 to rotate. The first electric motor 112 is configured to drive the fan blades 111 to rotate around an axis of the first electric motor 112. The first electric motor 112 is sealed by a waterproof material, so as to prevent water mist from entering the first electric motor 112 under the action of an environment or the like. For example, the waterproof material may be a plastic film, and the first electric motor 112 is sealed by the plastic film through a process such as hot blast.

The nozzle 13 is configured to spray water mist. The nozzle 13 is disposed on the fan assembly 11 or the body 12. When the misting fan 100 is started, the water mist is sprayed from the nozzle 13 into an ambient environment, and the fan blades 111 rotate to generate an air flow to blow the water mist sprayed from the nozzle 13 into the air, thereby reducing the temperature of the air in the environment.

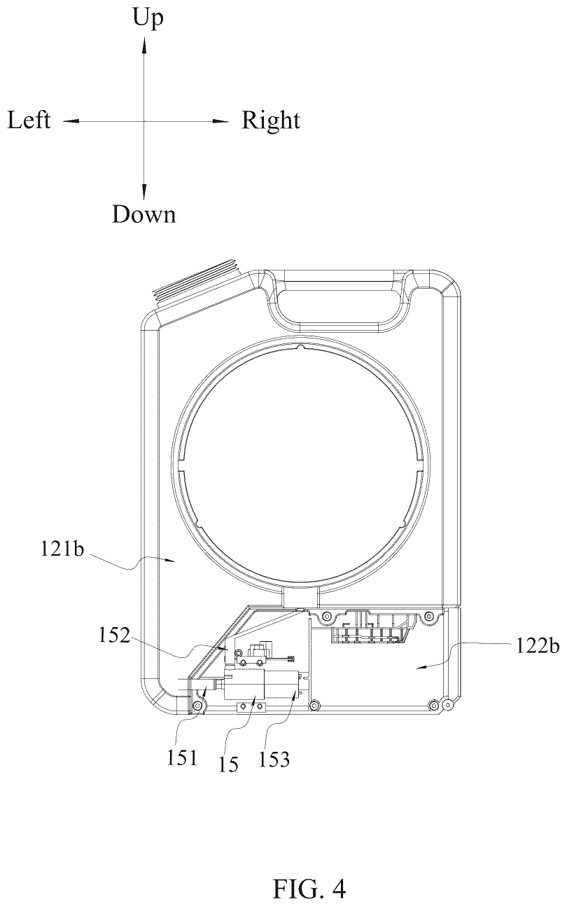

As shown in FIG. 4, the misting fan 100 further includes a pump component 15, where the pump component 15 is disposed in the second accommodation cavity 122b. The pump component 15 is configured to pump water in the first accommodation cavity 121b to the nozzle 13.

As shown in FIG. 4, the misting fan 100 further includes a water inlet pipe 151 and a water outlet pipe 152. One end of the water inlet pipe 151 is connected to the first accommodation cavity 121b and the other end of the water inlet pipe 151 is connected to the pump component 15 so that the water inlet pipe 151 can acquire water from the first accommodation cavity 121b and transport the acquired water to the pump component 15, and the pump component 15 receives the water acquired from the first accommodation cavity 121b. One end of the water outlet pipe 152 is connected to the pump component 15 and the other end of the water outlet pipe 152 is connected to the nozzle 13 so that water is transported from the pump component 15 to the nozzle 13, and the nozzle 13 can acquire water and spray water mist. The pump component 15 may be horizontally disposed in the second accommodation cavity 122b along the left and right direction, as shown in FIG. 4, or may be disposed in other manners, which are not limited in the present application. The water inlet pipe 151 and the water outlet pipe 152 may be connected to the pump component 15 in an arrangement manner shown in FIG. 4 or may be connected to the pump component 15 in other arrangement manners, which are not limited in the present application.

As shown in FIG. 4, the misting fan 100 further includes a second electric motor 153 for driving the pump component 15 to operate. The second electric motor 153 is connected to the pump component 15. The second electric motor 153 is configured to drive the pump component 15 to pump the water in the first accommodation cavity 121b to the nozzle 13, that is, the second electric motor 153 drives the pump component 15 so that the water inlet pipe 151 can acquire water from the first accommodation cavity 121b and the acquired water is pumped to the nozzle 13 through the water outlet pipe 152. The operating power of the pump component 15 is less than or equal to 10 W.

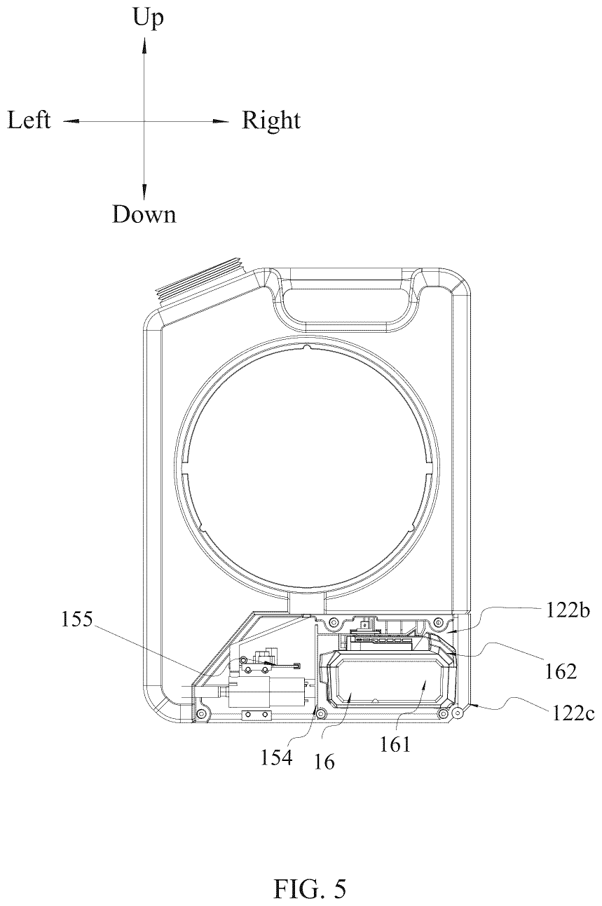

As shown in FIG. 5, the misting fan 100 further includes a battery assembly 16, the battery assembly 16 is disposed in the second accommodation cavity 122b, and the battery assembly 16 includes a battery pack 161 and a battery compartment 162. Since the pump component 15 is also disposed in the second accommodation cavity 122b, to improve the safety of the misting fan 100, a partition 154 may be disposed between the pump component 15 and the battery assembly 16. Thus, when the pump component 15 fails and water leakage occurs, the partition 154 can prevent the leaked water from flowing to the battery assembly 16, thereby ensuring the safety of the battery assembly 16.

Alternatively, in some examples, the second housing 122a or the first housing 121a is formed with an access port, and the battery pack 161 is detachably connected to the access port. When the battery pack 161 is mounted to the access port, the battery pack 161 is at least partially exposed. In other words, when the battery pack 161 is mounted to the access port, the battery pack 161 is located outside the first accommodation cavity and the second accommodation cavity, making it convenient for a user to observe the remaining power of the battery pack.

The battery pack 161 is configured to power the first electric motor 112 and the second electric motor 153 so that the first electric motor 112 drives the fan blades 111 to rotate and the second electric motor 153 drives the pump component 15 to operate. The battery pack 161 is connected to a circuit board assembly 155 and further powers the first electric motor 112 and the second electric motor 153 through the circuit board assembly 155. The circuit board assembly 155 is disposed in the second accommodation cavity 122b. Optionally, the circuit board assembly 155 includes a circuit board and a circuit board box. The circuit board is mounted in the circuit board box. When the circuit board is disposed in the circuit board box, a sealant may be injected into the circuit board box so that the waterproof performance of the circuit board assembly 155 can be improved. Alternatively, the circuit board assembly 155 may include only the circuit board, which is not limited in the present application.

In some examples, the battery pack 161 is detachably connected to the body 12, and the battery pack 161 is detachable from the battery compartment 162 in the second accommodation cavity 122b. When the battery pack 161 is mounted in the second accommodation cavity 122b, the first accommodation cavity 121b is at least partially disposed on the upper side of the battery pack 161 in the up and down direction so that the battery pack 161 is disposed in a lower part of the body 12, thereby improving the stability of the misting fan 100. When the battery pack 161 is not mounted in the second accommodation cavity 122b and is detached from the misting fan 100, the battery pack 161 may be used for powering other power tools.

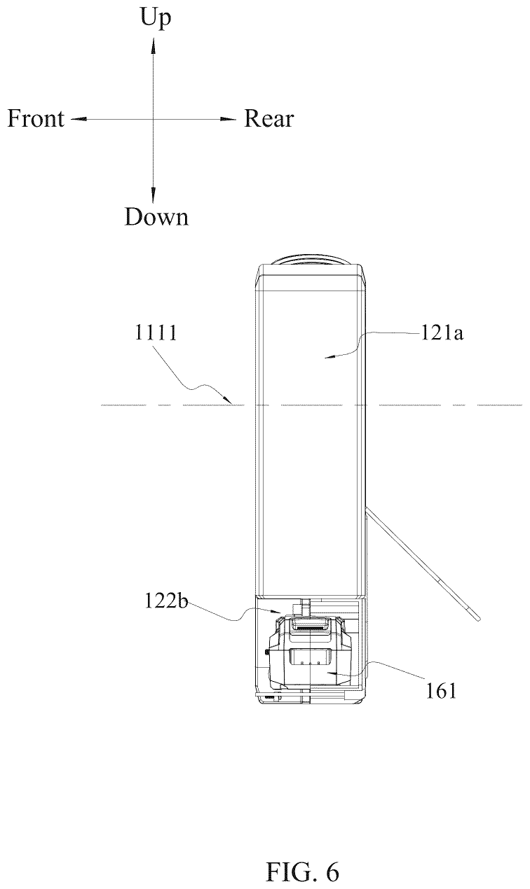

In some examples, the battery pack 161 is inserted into the second accommodation cavity 122b along the left and right direction. As shown in FIG. 6, to make the thickness of the body 12 of the misting fan 100 thinner, when the battery pack 161 is mounted in the second accommodation cavity 122b, the thickness of the battery pack 161 in a direction of a fan blade shaft 1111 of the fan blades 111 is less than or equal to 90 mm. For example, the thickness of the battery pack 161 may be 75 mm, 85 mm, or the like. That is, a thinnest surface of the battery pack 161 is opposite to a side surface of the body 12 so that the battery pack 161 is horizontally mounted in the second accommodation cavity 122b. Therefore, a mounting direction of the battery compartment 162 in the second accommodation cavity 122b matches that of the battery pack 161. As shown in FIG. 5, a first movable opening 122c is provided on a side surface of the second housing 122a. The first movable opening 122c is opened so that the battery pack 161 is inserted into the second accommodation cavity 122b from left to right or from right to left. An opening area of the first movable opening 122c is larger than an area of the thinnest surface of the battery pack 161. Optionally, the number of battery packs 161 may be greater than or equal to 1, and a nominal voltage of the battery pack 161 is greater than or equal to 6 V and less than or equal to 56 V. In some examples, the nominal voltage of the battery pack is greater than or equal to 3.6 V and less than or equal to 36 V. In some examples, the nominal voltage of the battery pack 161 is greater than or equal to 6 V and less than or equal to 36 V. In some examples, the nominal voltage of the battery pack is greater than or equal to 6 V and less than or equal to 24 V. A working current of the battery pack 161 is greater than or equal to 0.5 A and less than or equal to 5 A. For example, when the nominal voltage of the battery pack is 4 V and two battery packs 161 are connected in series, a nominal voltage of the battery assembly 16 is 8 V.

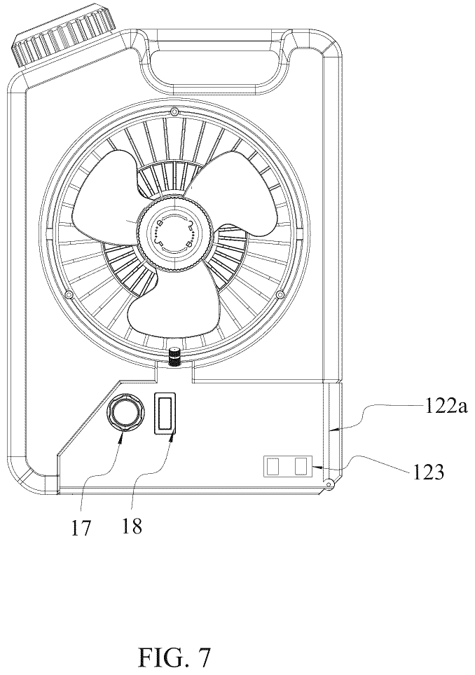

In some examples, as shown in FIG. 7, a power display component 123 is further provided on the body 12 of the misting fan 100, and a power status of the battery pack 161 is displayed by the power display component 123. The power display component 123 may be disposed on the second housing 122a and thus is relatively close to the battery pack 161, facilitating the display of the power status of the battery pack 161. The power display component 123 may include multiple display windows. When the battery pack 161 is fully charged, all the multiple display windows remain always on. When the battery pack 161 is half-charged, a half of the multiple display windows are always on and the other half of the multiple display windows are always off. In addition, the power display component 123 may display the power status of the battery pack 161 in other manners, which are not limited in the present application.

As shown in FIG. 7, the misting fan 100 further includes a water mist adjustment component 17, and the water mist adjustment component 17 is disposed on the second housing 122a of the misting fan 100. For convenience of operation of the user, the water mist adjustment component 17 is disposed on the front side (front surface) of the misting fan 100, that is, the front side (front surface) of the second housing 122a. The water mist adjustment component 17 is connected to the pump component 15 and configured to control an amount of water that the pump component 15 pumps from the first accommodation cavity 121b to the nozzle 13. Optionally, the water mist adjustment component 17 may be a knob-type component, as shown in FIG. 7. A knob is rotated so that the amount of water that the pump component 15 pumps to the nozzle 13 is controlled. For example, when the water mist adjustment component 17 is rotated to the leftmost side, the pump component 15 is in a non-working state, that is, the amount of water that the pump component 15 pumps to the nozzle 13 is 0. When the water mist adjustment component 17 is rotated to the rightmost side, the pump component 15 is in a working state and in a maximum working gear, that is, the amount of water that the pump component 15 pumps to the nozzle 13 is the maximum. In addition, when the water mist adjustment component 17 is rotated to the leftmost side, the pump component 15 may be in the working state and in the maximum working gear; when the water mist adjustment component 17 is rotated to the rightmost side, the pump component 15 is in the non-working state. Optionally, the water mist adjustment component 17 may be in another form with an adjustment function, such as a multi-gear button. The number of working gears of the pump component 15 may be 3, 4, or any number greater than or equal to 1, which is not limited in the present application.

As shown in FIG. 7, the misting fan 100 further includes a wind speed adjustment component 18, and the wind speed adjustment component 18 is disposed on the second housing 122a of the misting fan 100. For convenience of operation of the user, the wind speed adjustment component 18 and the water mist adjustment component 17 are disposed on the same surface of the misting fan 100. That is, the wind speed adjustment component 18 and the water mist adjustment component 17 are disposed on the front side (front surface) of the misting fan 100, that is, the front side (front surface) of the second housing 122a. The wind speed adjustment component 18 is connected to the fan assembly 11 and configured to adjust a wind speed of the fan assembly 11. Optionally, the wind speed adjustment component 18 may be a press-type component, as shown in FIG. 7. A button is pressed so that the wind speed of the fan assembly 11 is controlled. Optionally, when the button is pressed once, the wind speed of the fan assembly 11 is in a first gear, and when the button is pressed twice, the wind speed of the fan assembly 11 is in a second gear. The first gear may be a lowest gear and the second gear may be the highest gear; or the first gear may be the highest gear and the second gear may be the lowest gear. Optionally, besides the two wind speed gears of the fan assembly 11, the number of wind speed gears of the fan assembly 11 may be any number greater than or equal to 1, which is not limited in the present application. Optionally, the wind speed adjustment component 18 may be in another form with an adjustment function, such as a knob-type component, which is not limited in the present application.

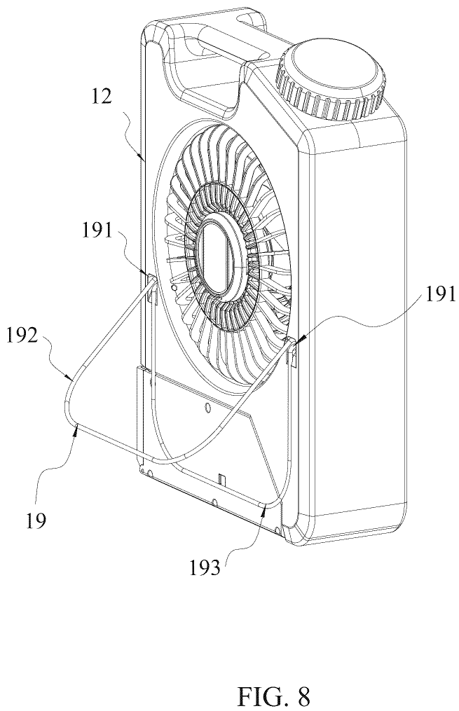

As shown in FIG. 8, the misting fan 100 further includes an angle adjustment component 19, and the angle adjustment component 19 is disposed on the body 12 and configured to adjust an angle at which the misting fan 100 operates, that is, adjust a standing angle of the misting fan 100. The angle adjustment component 19 enables the misting fan 100 to operate at an angle greater than or equal to 0° and less than or equal to 90°, that is, the angle adjustment component 19 can adjust the standing angle of the misting fan 100 to be greater than or equal to 0° and less than or equal to 90°. Thus, the misting fan 100 can be supported to stand at any angle between a standing angle of 90° (when the misting fan stands on a certain plane) and a standing angle of 0° (when the misting fan lies flat on a certain plane). To not affect the normal operation of the misting fan 100, the angle adjustment component 19 is disposed on the rear side of the misting fan 100, that is, a rear surface of the body 12. The angle adjustment component 19 includes a fixed end 191 and a movable end 192. To ensure the stability with which the angle adjustment component 19 adjusts the standing angle of the misting fan 100, the fixed end 191 of the angle adjustment component 19 is fixed to a rear surface of the first housing 121a. Specifically, the fixed end 191 of the angle adjustment component 19 is fixed at two ends of the rear surface of the first housing 121a on the left and right sides of the fan assembly 11. A line between the two ends may be parallel to a plane along the left and right direction or may not be parallel to the plane along the left and right direction as long as the angle adjustment component 19 stably supports the misting fan 100. The angle adjustment component 19 is a foldable component, that is, a storable component. A receiving groove 193 matching the angle adjustment component 19 is provided on the rear surface of the body 12. The receiving groove 193 includes a part disposed on the rear surface of the first housing 121a and a part disposed on a rear surface of the second housing 122a. When the angle adjustment component 19 is received in the receiving groove 193, the angle adjustment component 19 does not protrude from an outer surface of the body 12 so that the outer surface of the body 12 tends to be flat, making the misting fan 100 easier to store. Optionally, the angle adjustment component 19 may be a hinged support leg as shown in FIG. 8 or may be another component that can implement a support function, which is not limited in the present application.

In some examples, the volume (water storage capacity) of the first accommodation cavity 121b is less than or equal to 20 L. For example, the volume of the first accommodation cavity 121b may be 3.5 L. In some examples, the volume of the first accommodation cavity 121b is greater than or equal to 2 L and less than or equal to 15 L. Alternatively, in some examples, the volume of the first accommodation cavity 121b is greater than or equal to 2 L and less than or equal to 10 L. Alternatively, in some examples, the volume of the first accommodation cavity 121b is greater than or equal to 2 L and less than or equal to 6 L. The length of the first accommodation cavity 121b in the up and down direction is less than or equal to 600 mm; the width of the first accommodation cavity 121b in the left and right direction is less than or equal to 400 mm; and the thickness of the first accommodation cavity 121b in the front and rear direction is less than or equal to 200 mm. In some examples, the length of the first accommodation cavity 121b in the up and down direction is less than or equal to 450 mm; the width of the first accommodation cavity 121b in the left and right direction is less than or equal to 300 mm; and the thickness of the first accommodation cavity 121b in the front and rear direction is less than or equal to 150 mm. Alternatively, in some examples, the length of the first accommodation cavity 121b in the up and down direction is less than or equal to 450 mm; the width of the first accommodation cavity 121b in the left and right direction is less than or equal to 300 mm; and the thickness of the first accommodation cavity 121b in the front and rear direction is less than or equal to 130 mm. Optionally, when the volume of the first accommodation cavity 121b is 3.5 L, the length of the first accommodation cavity 121b is less than or equal to 400 mm, the width of the first accommodation cavity 121b is less than or equal to 290 mm, and the thickness of the first accommodation cavity 121b is less than or equal to 100 mm. Optionally, when the volume of the first accommodation cavity 121b is 18 L, the length of the first accommodation cavity 121b is less than or equal to 550 mm, the width of the first accommodation cavity 121b is less than or equal to 350 mm, and the thickness of the first accommodation cavity 121b is less than or equal to 150 mm. The first accommodation cavity 121b may be made by a blow molding process so that the body 12 is lighter and the misting fan 100 is lighter and more portable.

In some examples, the first accommodation cavity 121b is made of a light-transmissive material and the first housing 121a corresponding to the first accommodation cavity 121b is made of a light-transmissive material so that the first accommodation cavity 121b can display the water storage capacity of the misting fan 100. The light-transmissive material may be a semi-transmissive material. Since the first accommodation cavity 121b is made of the light-transmissive material, in the case of a light source, the first accommodation cavity 121b can scatter the light source and thus provide regional lighting for a region where the misting fan 100 is located. In addition, the first accommodation cavity 121b may be made of an opaque material, which is not limited in the present application.

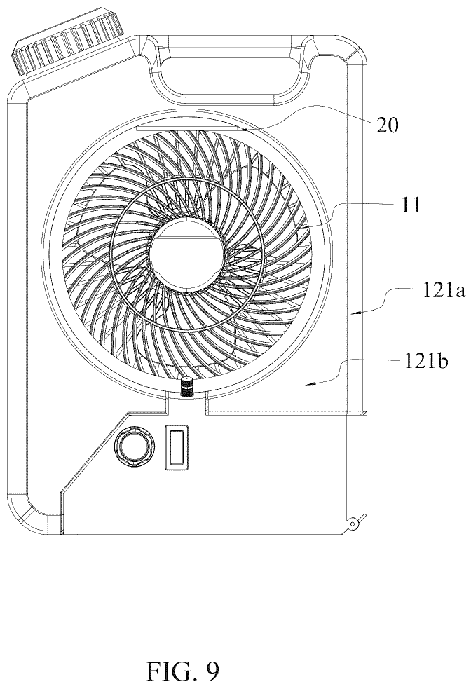

In some examples, the misting fan 100 further includes a light-emitting device 20. As shown in FIG. 9, the light-emitting device 20 may be mounted at a connection between the first housing 121a and the fan assembly 11. The light-emitting device 20 may provide, through the first accommodation cavity 121b, the regional lighting for the region where the misting fan 100 is located. The light-emitting device 20 may be mounted at a front connection between the first housing 121a and the fan assembly 11 or may be mounted at a rear connection between the first housing 121a and the fan assembly 11, which is not limited in the present application. Optionally, the light-emitting device 20 may be mounted around the fan assembly 11 by a cycle (360°), or the light-emitting device 20 may be mounted around the fan assembly by only 10°. In addition, the light-emitting device 20 may be mounted around the fan assembly by any degree greater than or equal to 0° and less than or equal to 360°, which is not limited in the present application. The light-emitting device 20 is powered by the battery pack 161.

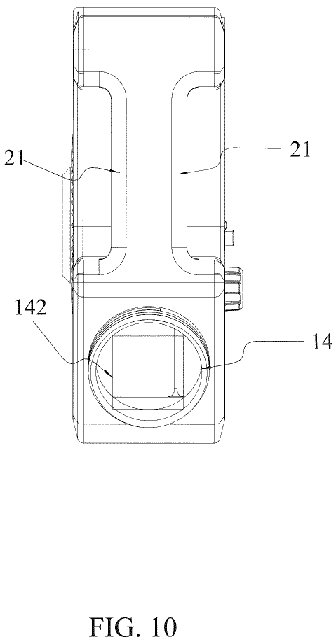

As shown in FIG. 10, the misting fan 100 further includes a handle component 21, and the handle component 21 is disposed on the first housing 121a corresponding to the first accommodation cavity 121b. The handle component 21 may be integrated with the first housing 121a, which are made together by the blow molding process. In addition, the handle component 21 may not be integrated with the first housing 121a, which is not limited in the present application.

As shown in FIG. 10, the handle component 21 and the water filling port 14 may be disposed on the upper side of the first housing 121a. The handle component 21 and the water filling port 14 are disposed on the same side so that the misting fan 100 is more conveniently filled with water. The water filling port 14 includes a filtering assembly 142. The filtering assembly 142 is disposed in the water filling port 14 and can filter foreign matters in the water injected into the first accommodation cavity 121b so that the nozzle 13 is not easily blocked by foreign matters during use. The filtering assembly 142 is detachably connected in the water filling port 14 so that the filtering assembly 142 is convenient to clean regularly. Optionally, when the volume of the first accommodation cavity 121b is 3.5 L, the nominal voltage of the battery pack 161 is 20 V, and the storage capacity of the battery pack 161 is 2.0 Ah, the battery pack 161 may support the misting fan 100 in operating for 1 h or more when the first accommodation cavity 121b has the maximum water storage capacity. That is, when the first accommodation cavity 121b of the misting fan 100 has the maximum water storage capacity, the misting fan 100 operates at a maximum wind speed (that is, the operating power of the fan assembly 11 is 15 W), and the nozzle 13 outputs a maximum amount of water (that is, the operating power of the pump component 15 is 5 W), the battery pack 161 supports the misting fan 100 in operating for 2 h. Optionally, when the volume of the first accommodation cavity 121b is 3.5 L, the nominal voltage of the battery pack 161 is 20 V, and the storage capacity of the battery pack 161 is 2.0 Ah, the battery pack 161 may support the misting fan 100 in operating for 1 h or more when the first accommodation cavity 121b has the maximum water storage capacity. That is, when the first accommodation cavity 121b of the misting fan 100 has the maximum water storage capacity, the misting fan 100 operates at a minimum wind speed (that is, the operating power of the fan assembly 11 is 3 W), and the nozzle 13 outputs a minimum amount of water (that is, the operating power of the pump component 15 is 3 W), the battery pack 161 supports the misting fan 100 in operating for 6 h. Optionally, when the volume of the first accommodation cavity 121b is 3.5 L, the nominal voltage of the battery pack 161 is 12 V, and the storage capacity of the battery pack 161 is 2.0 Ah, the battery pack 161 may support the misting fan 100 in operating for 1 h or more when the first accommodation cavity 121b has the maximum water storage capacity. That is, when the first accommodation cavity 121b of the misting fan 100 has the maximum water storage capacity, the misting fan 100 operates at the maximum wind speed (that is, the operating power of the fan assembly 11 is 15 W), and the nozzle 13 outputs the maximum amount of water (that is, the operating power of the pump component 15 is 5 W), the battery pack 161 supports the misting fan 100 in operating for 1 h. Optionally, when the volume of the first accommodation cavity 121b is 3.5 L, the nominal voltage of the battery pack 161 is 12 V, and the storage capacity of the battery pack 161 is 2.0 Ah, the battery pack 161 may support the misting fan 100 in operating for 1 h or more when the first accommodation cavity 121b has the maximum water storage capacity. That is, when the first accommodation cavity 121b of the misting fan 100 has the maximum water storage capacity, the misting fan 100 operates at the minimum wind speed (that is, the operating power of the fan assembly 11 is 3 W), and the nozzle 13 outputs the minimum amount of water (that is, the operating power of the pump component 15 is 3 W), the battery pack 161 supports the misting fan 100 in operating for 3 h.

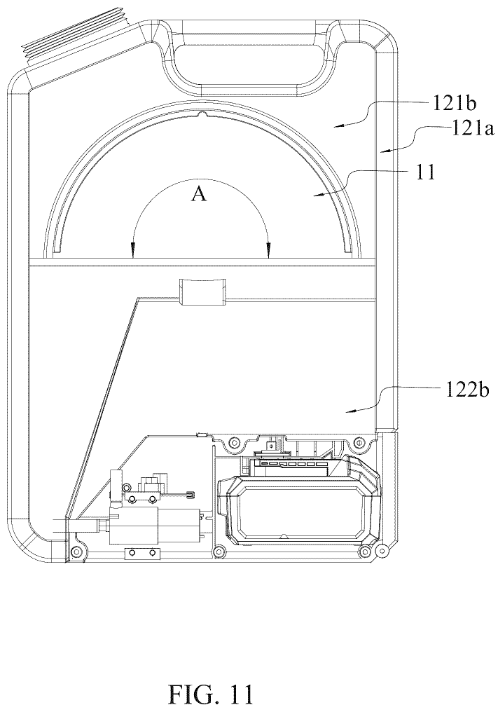

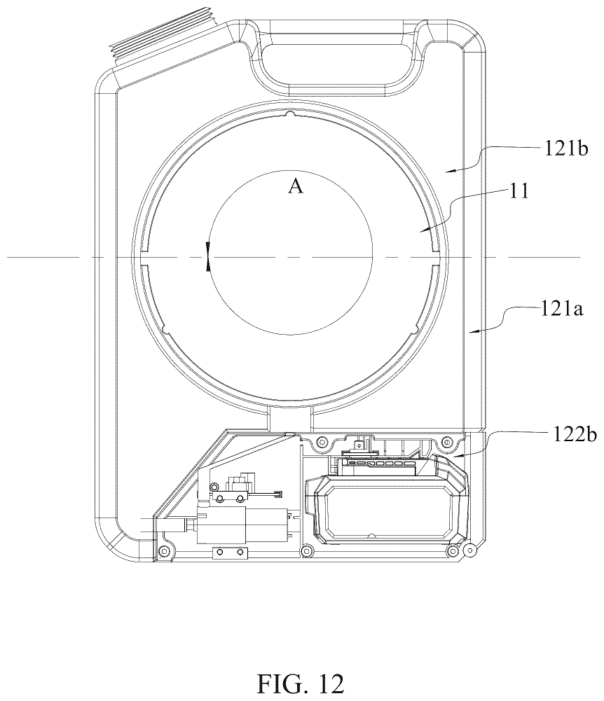

As shown in FIG. 11, when observing in a direction of a rotation shaft axis of the fan blades, the first accommodation cavity 121b is disposed around the fan assembly 11, and in a circumferential direction, the first accommodation cavity 121b forms an angle A around the fan assembly 11, where the angle A is greater than or equal to 180°. Optionally, as shown in FIG. 12, the angle A of the first accommodation cavity 121b around the fan assembly 11 may be 360°, and the first accommodation cavity 121b encircles the fan assembly 11 so that the fan assembly 11 is supported by a frame of the first housing 121a corresponding to the first accommodation cavity 121b. In some examples, in the circumferential direction, the angle A formed by the first accommodation cavity 121b around the fan assembly 11 is greater than or equal to 90°. In some examples, in the circumferential direction, the angle A formed by the first accommodation cavity 121b around the fan assembly 11 is greater than or equal to 120°. In some examples, in the circumferential direction, the angle A formed by the first accommodation cavity 121b around the fan assembly 11 is greater than or equal to 300°.

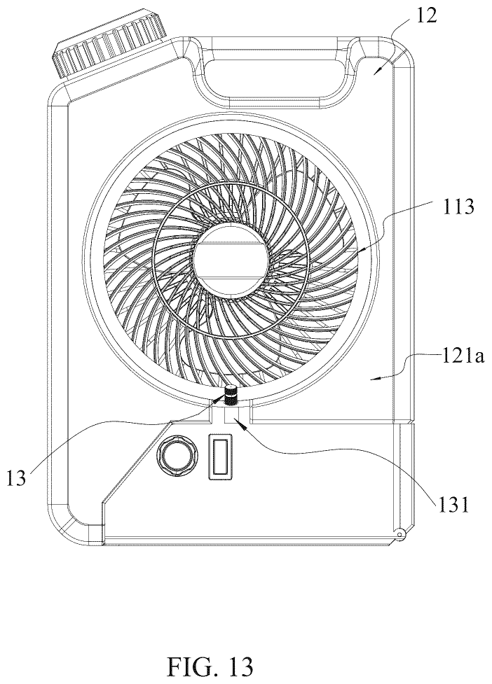

As shown in FIG. 13, the nozzle 13 is disposed on the body 12. Specifically, the nozzle 13 is disposed on the front side of the first housing 121a, that is, the front surface of the body 12. Optionally, the nozzle 13 is detachable. The nozzle 13 may be detached from the first housing 121a in case of a failure. Optionally, the nozzle 13 is also storable. A receiving groove 131 matching the nozzle 13 may be provided on the first housing 121a. When the nozzle 13 has no need to spray water, the nozzle 13 may be received in the receiving groove 131. When the nozzle 13 is received in the receiving groove 131, the nozzle 13 does not protrude from the outer surface of the body 12 so that the outer surface of the body 12 remains flat and the misting fan 100 is convenient to store. Optionally, the receiving groove 131 may be disposed at a position shown in FIG. 13 or may be disposed at another position on the front surface of the body 12 and where the nozzle 13 can be received, which is not limited in the present application. Optionally, the position of the nozzle 13 may be the lowest position at the connection between the fan assembly 11 and the first housing 121a, as shown in FIG. 13, that is, the lowest point past which the fan assembly 11 rotates. The position of the nozzle 13 may be any position at the connection between the fan assembly 11 and the first housing 121a, which is not limited in the present application.

In some examples, the diameter of the fan blades 111 of the fan assembly 11 is greater than or equal to 5 inches and less than or equal to 20 inches. For example, the diameter of the fan blades 111 of the fan assembly 11 may be 6 inches or 7 inches. In some examples, the diameter of the fan blades 111 of the fan assembly 11 is greater than or equal to 6 inches and less than or equal to 15 inches. In some examples, the diameter of the fan blades 111 of the fan assembly 11 is greater than or equal to 6 inches and less than or equal to 10 inches. When the fan assembly 11 operates, the operating power of the fan assembly 11 is greater than or equal to 3 W and less than or equal to 15 W. The wind speed at which the fan assembly operates is greater than or equal to 2.5 m/s. For example, the wind speed at which the fan assembly operates may be 6.4 m/s. In some examples, the operating power of the fan assembly 11 is greater than or equal to 3 W and less than or equal to 12 W. Alternatively, the operating power of the fan assembly 11 is greater than or equal to 3 W and less than or equal to 10 W.

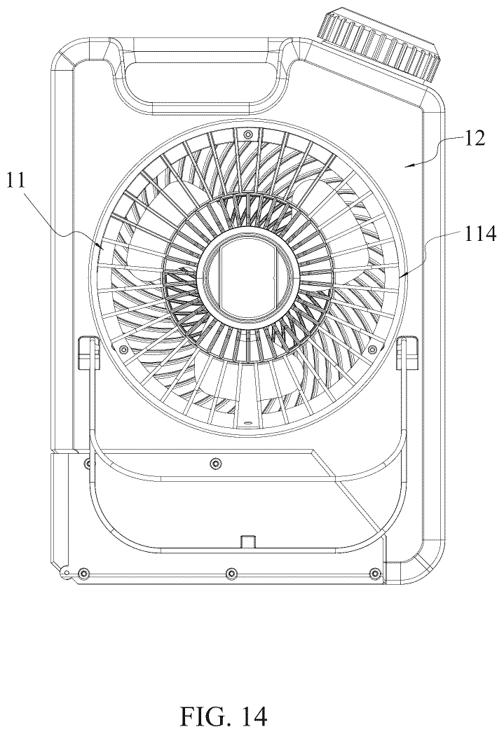

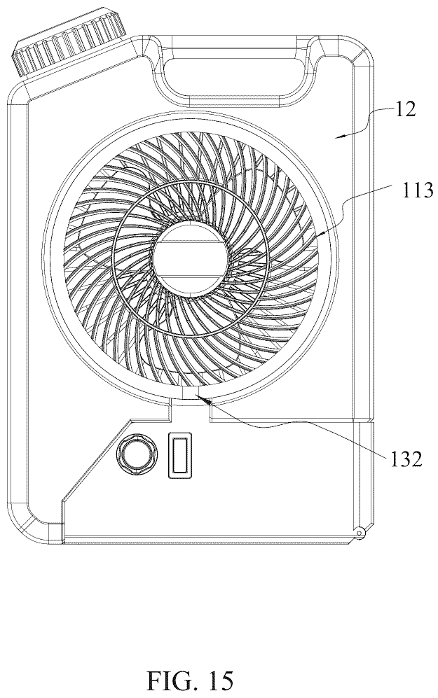

As shown in FIGS. 13 and 14, the fan assembly 11 further includes a front fan grille 113 and a rear fan grille 114, where both the front fan grille 113 and the rear fan grille 114 do not protrude from the outer surface of the body 12, that is, the front fan grille 113 does not protrude from the front side (front surface) of the body 12 and the rear fan grille 114 does not protrude from the rear side (rear surface) of the body 12 so that the outer surface of the misting fan 100 remains flat and the misting fan 100 is easier to store. In some examples, the nozzle 13 is disposed on the fan assembly 11. Specifically, the nozzle 13 may be disposed on the front fan grille 113 so that the nozzle 13 does not affect the normal operation of the fan assembly 11. Optionally, the nozzle 13 is detachable. Optionally, the nozzle 13 is also storable. When the nozzle 13 is storable, as shown in FIG. 15, a nozzle receiving groove 132 matching the nozzle 13 is provided on the front fan grille 113. When the nozzle 13 has no need to spray water, the nozzle 13 is received in the nozzle receiving groove 132. When the nozzle 13 is received in the receiving groove 132, the nozzle 13 does not protrude from the outer surface of the body 12 so that the outer surface of the body 12 remains flat and the misting fan 100 is easier to store. Moreover, when the misting fan 100 falls forward, the nozzle 13 may be received in the nozzle receiving groove 132 so that the nozzle 13 is not damaged, thereby improving the service life of the nozzle 13. Optionally, the position of the nozzle 13 on the front fan grille 113 is not limited in the present application, and the nozzle 13 may be disposed at any position on the front fan grille 113 and suitable for working. Optionally, the receiving groove 132 may be disposed at a position shown in FIG. 15 or may be disposed at another position on the front surface of the front fan grille 113 and where the nozzle 13 can be received, which is not limited in the present application.

In some examples, the number of nozzles 13 may be 1, as shown in FIG. 13. The number of nozzles 13 may be 2, 3, or any positive integer greater than or equal to 1, which is not limited in the present application. In some examples, the nozzle 13 may spray water intermittently, thereby saving the water in the first accommodation cavity 121b while ensuring the function of the misting fan 100. The nozzle 13 may spray water continuously, which is not limited in the present application.

In some examples, the front fan grille 113 is recessed to a certain extent relative to the front surface of the body 12 so that the light-emitting device 20 can be mounted on the front fan grille 113. The rear fan grille 114 may be recessed to a certain extent relative to the rear surface of the body 12 so that the light-emitting device 20 may be mounted on the rear fan grille 114. In addition, the light-emitting device 20 may be mounted on both the front fan grille 113 and the rear fan grille 114, which is not limited in the present application.

Currently, an existing misting fan needs to be connected to an external water bucket or a tap water pipe during use. As a result, the misting fan is not convenient to use and cannot spray water once disconnected from the water bucket or the tap water pipe. The misting fan 100 of the present application uses the body 12 as the frame for supporting the fan assembly 11 and also a water storage device of the misting fan 100 so that the misting fan 100 is more convenient to use. Even if the misting fan 100 is far away from a water source, the misting fan 100 can spray water by relying on water stored in the body 12. Moreover, when the misting fan 100 requires water addition, the whole misting fan 100 may be directly moved for water addition, and there is no need to disconnect the misting fan from the water bucket and add water to the water bucket as in the existing art. Meanwhile, when the misting fan needs to be moved, the misting fan 100 of the present application is also more convenient to move. In addition, the body 12 of the misting fan 100 of the present application has the cubic structure so that the misting fan 100 can be neatly arranged when stored and is convenient to store.

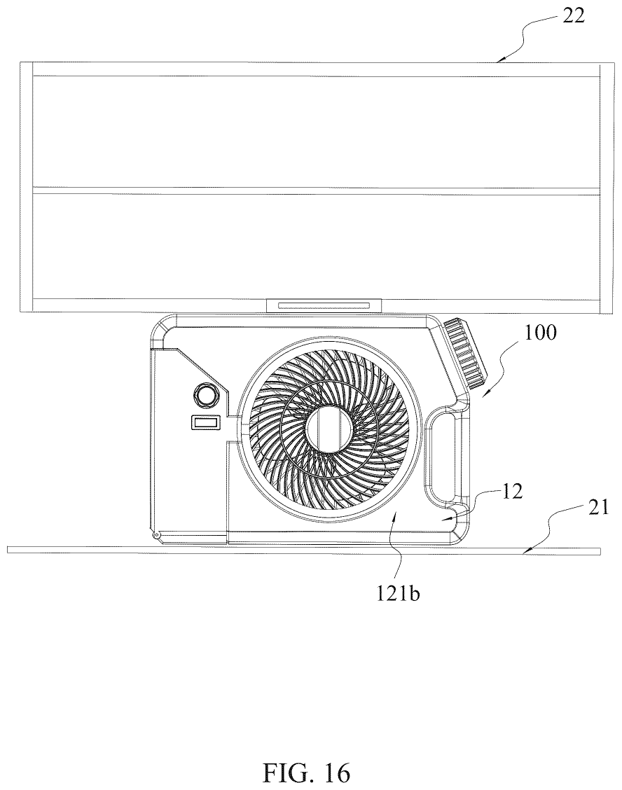

In some examples, as shown in FIG. 16, the left and right side surfaces of the first accommodation cavity 121b of the misting fan 100 are two planes parallel to each other, that is, the left and right side surfaces of the first housing 121a are two planes parallel to each other so that the misting fan 100 can be placed on a side on a windowsill 21 and the misting fan 100 can be clamped and fixed between the windowsill 21 and a window 22. The misting fan 100 is used as a window fan. Optionally, the length of the body 12 of the misting fan 100 in the up and down direction is less than or equal to 600 mm, and the width of the body 12 in the left and right direction is less than or equal to 400 mm. Optionally, the length of the body 12 of the misting fan 100 in the up and down direction is less than or equal to 600 mm, and the thickness of the body in the front and rear direction is less than or equal to 200 mm. In some examples, the length of the body 12 of the misting fan 100 is less than or equal to 500 mm, the width of the body 12 in the left and right direction is less than or equal to 300 mm, and the thickness of the body in the front and rear direction is less than or equal to 130 mm. In some examples, the length of the body 12 of the misting fan 100 is less than or equal to 450 mm, the width of the body 12 in the left and right direction is less than or equal to 300 mm, and the thickness of the body in the front and rear direction is less than or equal to 110 mm.

In some examples, the misting fan 100 may be powered by the battery pack 161. In some examples, the misting fan 100 includes a plug component, and the misting fan 100 may be powered by the plug component mating with a socket.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A misting fan, comprising:
a fan assembly comprising fan blades and a first electric motor for driving the fan blades to rotate;
a body formed with a first frame for supporting the fan assembly and formed with a first accommodation cavity disposed around the fan assembly for water storage wherein, in a circumferential direction, an angle of the first accommodation cavity around the fan assembly is greater than or equal to 180°;
a nozzle disposed on the fan assembly and/or the body; and
a pump component for pumping water in the first accommodation cavity to the nozzle.

2. The misting fan according to claim 1, wherein, in the circumferential direction, the angle of the first accommodation cavity around the fan assembly is equal to 360°, and the first accommodation cavity encircles the fan assembly so that the fan assembly is supported by a second frame of a housing of the first accommodation cavity.

3. The misting fan according to claim 1, wherein the nozzle is disposed on a housing of the first accommodation cavity.

4. The misting fan according to claim 2, wherein the nozzle is detachable.

5. The misting fan according to claim 2, wherein the housing of the first accommodation cavity further comprises a nozzle receiving groove matching the nozzle, and, when the nozzle has no need to spray water, the nozzle is received in the nozzle receiving groove and does not protrude from an outer surface of the body.

6. The misting fan according to claim 1, wherein the body is further provided with a water filling port through which water is injected into the first accommodation cavity.

7. The misting fan according to claim 1, wherein the first accommodation cavity is made of a light-transmissive material and the first accommodation cavity is configured to display a water storage capacity of the misting fan.

8. The misting fan according to claim 7, wherein the first accommodation cavity is further configured to scatter a light source to provide regional lighting for a region where the misting fan is located.

9. The misting fan according to claim 8, wherein a light-emitting device is disposed at a connection between a housing of the first accommodation cavity and the fan assembly, and the light-emitting device provides, through the first accommodation cavity, the regional lighting for the region where the misting fan is located.

10. The misting fan according to claim 1, further comprising an angle adjustment component, wherein the angle adjustment component is disposed on a housing of the first accommodation cavity and configured to adjust an angle at which the misting fan operates.

11. The misting fan according to claim 10, wherein the angle adjustment component enables the misting fan to operate at an angle greater than or equal to 0° and less than or equal to 90°.

12. The misting fan according to claim 1, further comprising a battery assembly comprising a battery pack for powering the first electric motor, wherein the battery pack is detachably connected to the body.

13. The misting fan according to claim 12, wherein the body is further formed with a second accommodation cavity, and the battery assembly is disposed in the second accommodation cavity.

14. The misting fan according to claim 1, wherein the fan assembly further comprises a fan with a diameter greater than or equal to 5 inches and less than or equal to 20 inches.

15. The misting fan according to claim 1, wherein left and right side surfaces of the first accommodation cavity are two planes parallel to each other, and the left and right side surfaces enable the misting fan to be clamped and fixed between a windowsill and a window.

16. A misting fan, comprising:
a fan assembly comprising fan blades and a first electric motor for driving the fan blades to rotate;
a body formed with a frame for supporting the fan assembly and formed with a first accommodation cavity for water storage, wherein the first accommodation cavity is disposed around the fan assembly, and a volume of the first accommodation cavity is less than or equal to 20 L;
a nozzle disposed on the fan assembly and/or the body; and
a pump component for pumping water in the first accommodation cavity to the nozzle.

17. The misting fan according to claim 16, further comprising a water inlet pipe, wherein one end of the water inlet pipe is connected to the first accommodation cavity to acquire water from the first accommodation cavity, and another end of the water inlet pipe is connected to the pump component to receive the water acquired from the first accommodation cavity.

18. The misting fan according to claim 16, further comprising a water outlet pipe, wherein one end of the water outlet pipe is connected to the pump component to acquire water from the pump component, and another end of the water outlet pipe is connected to the nozzle to provide the water for the nozzle.

19. The misting fan according to claim 16, further comprising a second electric motor for driving the pump component to operate, wherein the second electric motor is configured to drive the pump component to pump the water in the first accommodation cavity to the nozzle.

20. The misting fan according to claim 16, wherein the body is further formed with a second accommodation cavity, and the pump component is disposed in the second accommodation cavity.
